(19) United States
(12) Patent Application Publication
(10) Pub. No.: US 2003/0014297 A1
(43) Pub. Date: Jan. 16, 2003

(54) Automated location-based disruption recovery and surrogate selection service

(75) Inventors: James H. Kaufman, San Jose, CA (US); Reiner Kraft, Gilroy, CA (US); Joann Ruvolo, San Jose, CA (US)

Correspondence Address: Samuel A. Kassatly, 6819 Trinidad Drive, San Jose, CA, 95120, US

(73) Assignee: International Business Machines Corporation, Armonk, NY (US)

(21) Appl. No.: 09/903,360

(22) Filed: Jul. 10, 2001

(51) Int. Cl. G06F 17/60

(52) U.S. Cl. 705/9

(57) ABSTRACT

An automated disruption recovery system and associated methods address off-normal or emergency events by automatically identifying and contacting individuals or service providers whose capabilities fit the needs of the situation. The system automatically provides a list of potential service providers based on a number of criteria, many of which are defined by the user, and based on other criteria that are automatically defined by the user's current location, situation and need. Thus, selecting, scheduling, and dispatching of surrogate or disruption recovery services is based on time-sensitivity, location information, and conflict/situation definition.

### FIELD OF THE INVENTION

The present invention relates generally to event-driven automated notification systems. More specifically, this invention relates to an automated notification system and associated method for obtaining services, or surrogates in response to a disruption of a normal chain of events. In particular, in response to the system notification, services are rendered by one or more individuals or service providers who meet the pre-defined response criteria for the off-normal event, i.e., they have the requisite knowledge, expertise, equipment, response time and willingness for addressing the situation at hand.

### BACKGROUND OF THE INVENTION

Individuals quite often discover that they require unanticipated services. The need for the services arises as the result of one or more unexpected or unplanned events that leaves them incapable of responding in an appropriate manner, or within a required timeframe. Typically, finding the individual to provide the services needed to resolve the problem in an expedient manner is difficult or even impossible.

The following represent exemplary situations in which individuals might require assistance or services:

An individual is preparing for a presentation when his/her computer fails.

A flight is cancelled, leaving a businessperson stranded at an airport and unable to reach the next scheduled appointment.

A work assignment requires knowledge that is out of the field or beyond the worker's levels of expertise.

A parent is unable to pick up a child at a daycare because an important meeting is running overtime.

The specific solution to these problems is, of course, situation- and time-dependent. In the case of the failed computer, the client may need expert help in the form of technical support either over the phone or in person. The cancelled flight may require the re-routing and/or re-scheduling of a surrogate person with the same, similar, or missing expertise. The difficult work assignment may require the identification of a consultant with the required expertise. The daycare situation may be remedied with a simple notification of a neighbor or a shuttle service that is in the general neighborhood of the child's care-provider.

However, in a typical scenario there is no logical or systematic means of dealing with these situations, especially when a rapid response is required. There exists no viable support system in place and the chances of success, with or without major effort, are small. Thus, the need for such a notification system, that provides the required services in response to a disruption or the need for a surrogate, remains unfulfilled.

### SUMMARY OF THE INVENTION

The automated notification system (or disruption recovery system) fulfills this need by providing a process for addressing off-normal or emergency events by automatically identifying and contacting individuals or service providers whose capabilities fit the needs of the situation. The system provides a list of potential service providers based on a number of criteria, many of which are defined by the user (via a pre-existing personal preferences file), and based on other criteria that are automatically defined by the user's current location, situation and needs. Thus, selecting, scheduling, and dispatching of surrogate or disruption recovery services is based on time-sensitivity, location information, and conflict/situation definition.

The potential service providers, chosen from a list stored in a profile database, meet the following general criteria:

The service providers or helpers must meet the context-specific requirements of the situation, that is, they must have the necessary skills, knowledge, or resource (e.g., transportation) for the situation at hand.

The service provider must be able to provide the service within the required timeframe.

The service provider is acceptable to the user.

Typically, the client will have supplied service provider preferences via his or her profile information and can make the final choice of the service provider, though certainly in emergency situations, e.g., where the system determines that the user is incapacitated to some level, the notification system could determines the outcome autonomously. The service providers have some latitude in providing the service, as well, depending on their current status.

In operation, a user can submit a request for a service that needs to be rendered at the user's current or desired physical location (e.g., transportation request, surrogate request, etc.). A potential service provider will be selected based on the user preferences and his or her ability to meet the requirements of the situation, and will be notified automatically about this service request. The service provider, in turn, fulfills the context-specific criteria of the service call.

In a preferred embodiment, the system is capable of instantly receiving and acting upon requests for aid from users, such as: 911 emergency calls, requests for transportation, technical assistance and information, surrogate requests, and notification of other system clients about schedule/priority changes. The use of the present notification system results in a quick, logic-driven identification and notification of those who can supply help. The user in need is no longer required to effect his or her own rescue at a moment's notice, but can rather rely on competent help from other users.

### BRIEF DESCRIPTION OF THE DRAWINGS

The various features of the present invention and the manner of attaining them will be described in greater detail with reference to the following description, claims and drawings, and wherein:

FIG. 1 is a schematic illustration of an exemplary operating environment in which an automated notification system of the present invention can be used;

FIG. 2 is a block diagram of a high level architecture showing the notification system in use with a GPS system;

FIG. 3 is a block diagram of an exemplary client module that forms part of the system of FIG. 2;

FIG. 4 is a block diagram of an exemplary helper module that forms part of the system of FIG. 2;

FIG. 5 is a block diagram of a server that forms part of the system of FIG. 2; and

FIG. 6, which is comprised of FIGS. 6A, 6B, 6C, and 6D, is a process flow chart illustrating a method used by the system of FIG. 2 to implement a disruption recovery feature or a surrogate selection feature.

### DETAILED DESCRIPTION OF THE PREFERRED EMBODIMENTS

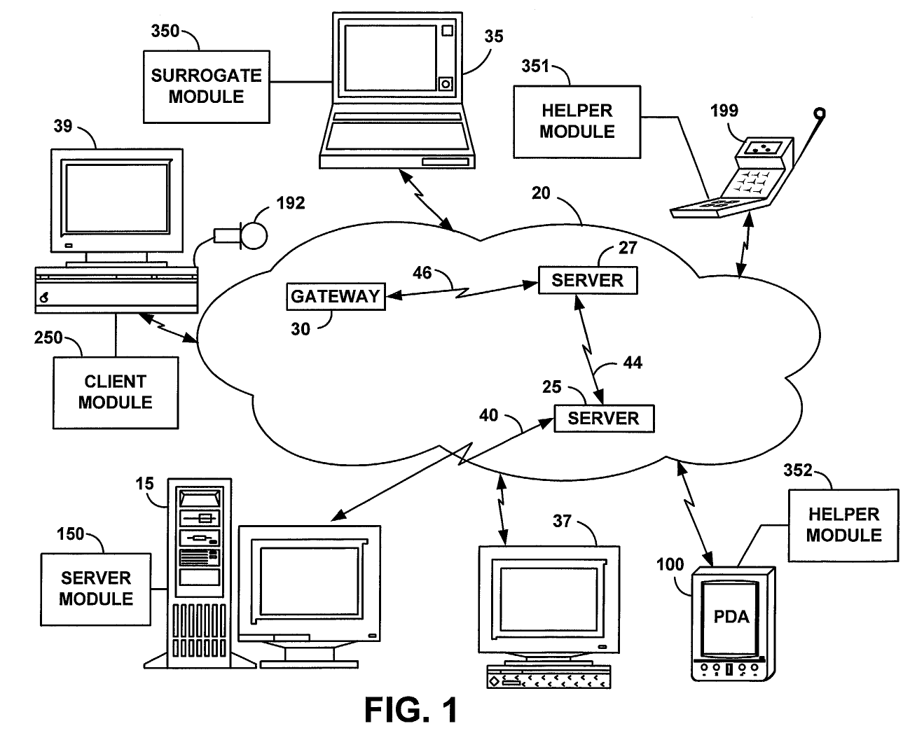

FIG. 1 portrays an overall environment in which a location based disruption recovery and surrogate selection system (also referred to as notification system) 10 may be used in accordance with the present invention. Although an exemplary preferred embodiment of the system 10 will be described herein in connection with the World Wide Web (WWW) 20 or a GPS system 450, it should be clear that the system 10 could be used with any adequate telecommunications or data network.

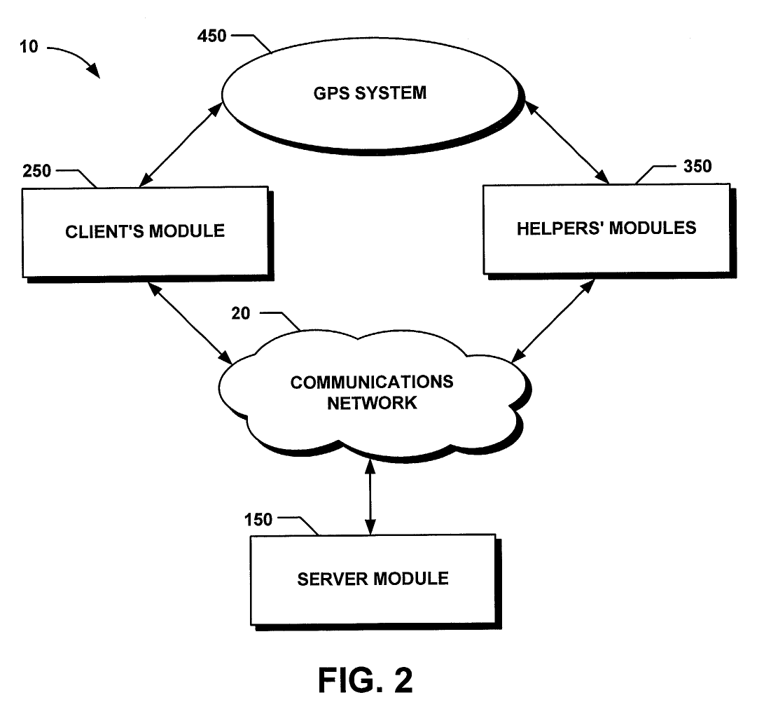

In the exemplary illustration shown in FIGS. 1 and 2, a server module 150 of the system 10 is embedded within, or installed on a host server 15, and a plurality of helpers' modules 350, 351, 352, are embedded within, or installed on a laptop computer 35, a cellular telephone 199, and a personal digital assistant (PDA) 100, respectively. In an alternative embodiment, some of the various components of the system 10 can be saved on a suitable storage medium such as a diskette, a CD, a hard drive, or like devices.

The WWW is represented as a cloud-like communication network 20 and is comprised of communication lines and switches connecting servers such as servers 25, 27, to gateways such as gateway 30. The servers 25, 27 and the gateway 30 provide the communication access to the server 15. For illustration purposes only, and without intent to limit the scope of the invention, the various users are represented by a variety of computers such as computers 35, 37, 39, and a variety of other interface devices and/or appliances, such as the mobile telephone 199 and the PDA 100.

The host server 15 is connected to the network 20 via a communications link such as a telephone, cable, satellite link, or cellular radio network 40. The servers 25, 27 can be connected via high-speed Internet network lines 44, 46 to other computers and gateways.

The following exemplary cases illustrate the utility of the notification system 10:

The car of User A (represented by a client module 250 and a computer 39) fails and stops running on the morning of an important meeting. User A, now requiring disruption recovery, issues a transportation service request to the system 10, using a microphone 192, or some other data entry device. The user's profile database, which forms part of the server module 150, designates a number of potential candidates (perhaps co-workers of User A), represented, for example, by helper modules 351, 352) and who might reasonably be able to deviate from their normal routes, pick up User A at his or her current location and, thus, provide the required transportation to the work site.

The notification system 10 then uses calendar information from each of these candidates to determine their current schedules. In addition, their current physical location, along with route information, could, for example, be obtained using a GPS system 450 (FIG. 2). The candidates would be ranked based on location, availability, user preference and other criteria explicitly contained within the system.

These criteria could alternatively be weighted to generate the final ranking. The highest ranked candidate is then notified via telephone, e-mail, or other electronic communication, and asked to pick up User A where his or her car is currently parked. Each candidate has the option of declining the request, and at that point another candidate (the next lower in the ranking list) would be selected. Once a candidate accepts the request, User A will be notified and can wait to be picked up. Should there be no candidate available to meet User A's request, User A will also be notified, in order to arrange an alternative means of getting to work on time, e.g. taxi cab or public transportation.

As another example, a sales representative (represented by client module 250) for a company subscribed to the service provided by the current notification system is delayed in Chicago during a stop-over while traveling from San Francisco to New York. Due to this delay, the sales representative will be unable to attend a meeting in New York with an important customer and, thus, requires a surrogate service. The sales representative is but one of several team members from the company who are traveling throughout the country and who are cross-trained to cover for each other.

In this case, the stranded company representative notifies the system 10 that she is delayed in Chicago and needs a surrogate to stand in for her at this important meeting. The notification system 10 actively maintains calendar information on all the users, identifies the subject and time of the required meeting, and generates a list of qualified surrogates (represented by surrogate module 350).

The notification system then checks the calendars, current locations, and status of these qualified surrogates, giving a pre-determined weighting to each criterion, to generate the list of candidate surrogates. As an example, the notification system identifies two sales representatives of the company who could help. One is in Newark Airport awaiting a flight home, while another is in Boston having attended a meeting that just ended. Giving consideration to the importance of the meeting with the client in New York, the client picks the employee located in Boston whose skills more closely align with those of the stranded representative.

The notification system 10 contacts the employee in Boston and asks her to drive to New York to attend the meeting. In one embodiment, the client (represented by client module 250) has the option to make the final decision on who will help based on the list of candidate helpers or surrogates, provided by the notification system. In another embodiment, a third party, or the notification system 10 makes the final choice based on the list generated by the system 10.

An explanation of certain attributes of the following components of the system 10, along with related technical definitions, will assist in a better appreciation of the features offered by the system 10:

GPS technology is used for location tracking and monitoring of clients and service providers. The basic component is the constellation of global positioning satellites in orbit around the earth, initially deployed by the US Government.

A GPS Interface is implemented as a miniaturized GPS receiver that determines an exact position of the antenna (latitude, longitude, and altitude) based on input from the GPS satellites. The GPS receiver interface determines a current location of the GPS client wireless component and supplies the current location to the client session manager.

A WAN or Cell Phone Interface supports a wireless connection to the network 20, i.e., Internet or Intranet. Through this interface the GPS client wireless component is connected to the server 15, and the Internet or phone system network 20.

An output device of the I/O component would typically be implemented as a display of a wireless device and the input device as a touch screen or phone keyboard. The touch screen can be used for manual user inputs and configuration, while the display can be used for output of messages.

A location based disruption recovery and surrogate service server component is a web-based electronic active calendaring and profile system. One of the key features of the system is that it automatically executes tasks. This component automatically identifies service providers and/or surrogates and sends events and information to a specific user.

A GPS client wireless interface may be implemented on a laptop computer, cell phone, personal digital assistant (PDA) or integrated in a car system having a wireless wide area network (WAN) connection for communicating with an active calendar and server. The client wireless interface includes a GPS interface for receiving location information. This component constantly updates the location of the current user and then transmits this information to an active cooperative location-based server that forms part of the server module 150. The active cooperative location-based server is employed to maintain the current location of all users. In addition, the client wireless interface receives data from a server module and displays it for the user on a display device. The GPS client wireless interface operates under the control of the client session manager.

The client session manager is responsible for managing the interaction between the sub-components of the client wireless component. It manipulates the incoming data, typified by location, to-do list entries, surrogate and disruption recovery requests, and sends the data either to the active to-do list over the WAN interface or displays them over the GUI on a screen portable device.

The server session manager is responsible for the communication and interaction between the internal components of the location based server. Furthermore, it measures periodically the position of users relative to specific locations that are defined and stored in a locations database.

The client database contains information about the clients (or users) on the system 10, including those available as surrogates or for implementing disruption recovery.

The client interface contains the software methods used by the server session manager to access and modify the client database.

The profiles database contains relevant information about the various clients in the system 10. This would typically include information such: e-mail addresses, vehicle ownership, their field(s) of expertise, skill-set, a list of tasks they are capable of performing, and times required to accomplish certain pre-defined tasks. It also contains clients' user preferences such as “I prefer not to ride in John Doe's car,” or “My children prefer to be picked up by a female surrogate.”

The profiles interface contains the software methods used by the server session manager to access and modify the profiles database.

The phone database contains telephone numbers of the various users or clients in the system 10.

The phone interface contains the algorithms used by the server session manager to access and modify the phone database.

The calendar database contains client calendar information, including nominal workday, major meetings, appointments, etc.

The calendar interface contains the software methods used by the server session manager to access and modify the calendar database.

The locations database contains information about the current location of important clients and other mobile entities (cars, airplanes etc). The server session manager accesses this database, for example, to determine if a colleague of the client is currently in his/her office.

The locations interface contains the methods used by the server session manager to access and modify the locations database.

The status database contains information about the current status of the system 10.

The status interface contains the methods used by the server session manager to access and modify the status database.

The surrogate database contains information about the surrogates the client may use.

The surrogate interface contains the methods used by the server session manager to access and modify the surrogate database.

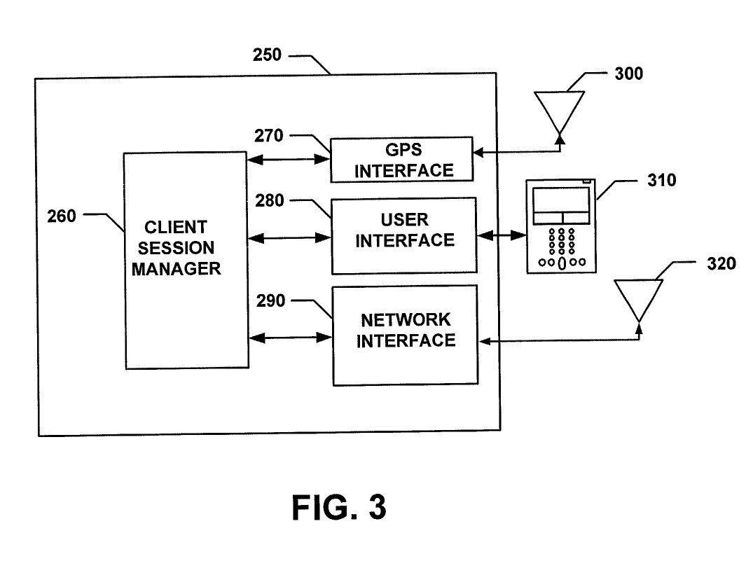

FIGS. 3, 4, and 5 illustrate the main components of the notification system 10. The system 10 is a novel, fully integrated combination of hardware and software products that have never before been available as a unified product.

The server module (or location-based disruption recovery and surrogate selection server) 150 is illustrated in FIG. 5, and includes a network interface 540, such as a WAN/cell phone interface, a server session manager 25, server information interfaces 530, and server information databases 535. The server module 150 contains the information, algorithms, and methods necessary to implement the desired service.

More specifically, the server module 150 includes the necessary functionality required to categorize “calls for help,” to correctly assess the needs of the user, to determine a list of potential respondents, and to initiate the necessary contact service to resolve the situation/crisis at hand. In addition, the server module 150 manages and maintains current information about users and service providers, including the users' current locations as determined by a location determining system, such as the GPS system 450 of FIG. 2.

The server session manager 25 contains one or more algorithms that control or manage the server selection process. The session manager is interfaced to the network interface 540 giving it a communication link to the network 20. Internally, the session manager communicates with the server information interface 530.

In a preferred embodiment, the server information interface 530 comprises a client Interface 45, a surrogate interface 50, a profile Interface 55, a calendar interface 60, a location interface 65, a status interface 70, and a phone interface 75. These interfaces are, in turn, connected to respective databases of the server information databases 535.

In a preferred embodiment, the server information databases 535 include the following exemplary databases:

A client database 80 that contains a list of all current users or clients;

a surrogate database 85 that contains a list of all potential surrogates;

a profile database 90 that contains all the users' profiles including preferences;

a calendar database 95 that contains actively maintained calendar information on all users and potential service providers;

a locations database 100 that contains information about the current location of each user and potential service provider;

a status database 105 that contains information about the status and availability of the system users; and

a phone database 110 that contains current telephone number information about the system users.

The databases 80, 85, 90, 95, 100, 105, and 110 store the current information on users and service providers alike. It is through these interfaces 530 and databases 535 that the server session manager 25 accesses the archived information necessary to maintain, manage, and implement the disruption recovery service and the surrogate selection service of the system 10.

As illustrated in FIG. 2, the communications network 20 serves as a conduit between server module 150, the client's module 250, and the helpers' modules (also referred to herein as service providers' modules) 350. The client's module 250 resides with the user, serving as the client's primary contact to the server 15 (or more specifically to the server module 150).

With reference to FIG. 3, the client's module 250 comprises a client session manager 260, a GPS interface 270, a user interface 280 (such as a GUI, a PDA, or a mobile phone interface), and a network interface (such as WAN or a mobile phone interface). The client session manager 260 contains the algorithms necessary to manage and internally process the user's request for disruption recovery or surrogate aid, along with any information provided by the server module 150.

Specifically, the session manager 260 communicates with the GPS Interface 270, the user interface 280, and the network interface 290. Thus, it is capable of receiving and managing real-time information related to the location of the user, information inputted by the user via an input device such as a PDA 310, as well as information provided to the client from the server 15, through the network 20 via a transceiver or antenna 320. The GPS system 300, through a transceiver or antenna 300, relays current location information to the client session manager 260, providing necessary user location information for proper disruption recovery or surrogate selection.

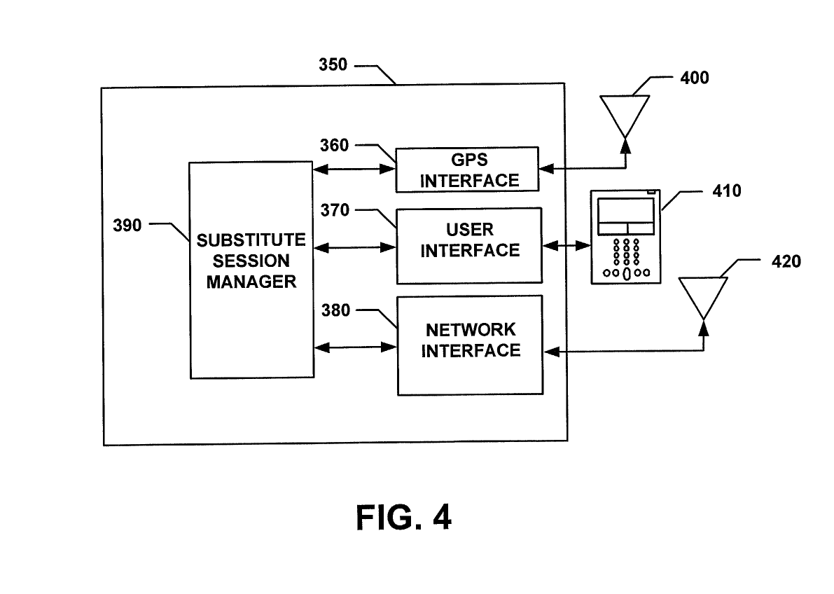

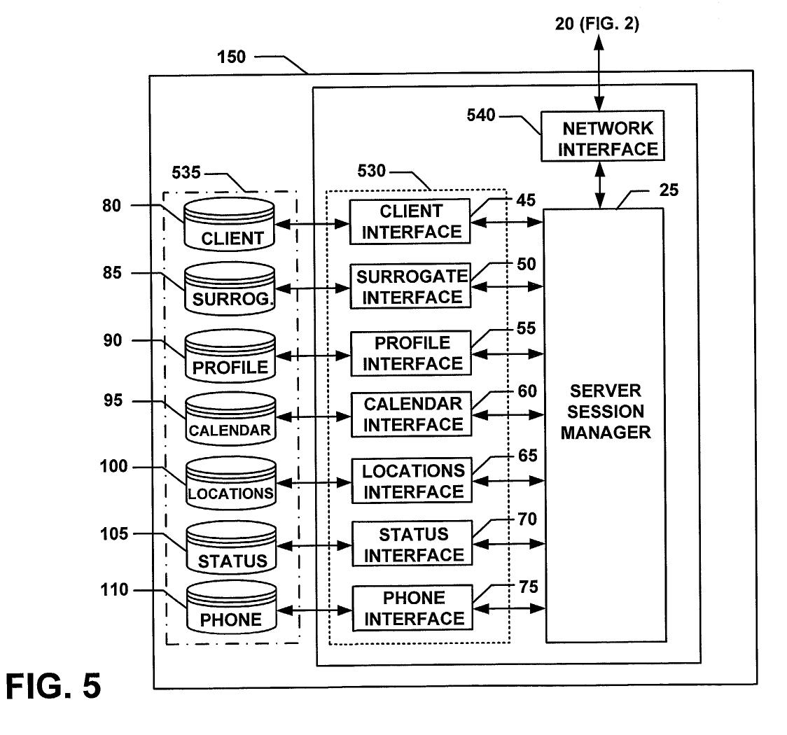

With reference to FIG. 4, and as indicated earlier, the communications network 20 serves a conduit between the server 15 and the helper/service provider module 350. The helper module 350 resides with a user or a service provider for communicating and receiving information related to the system's service provider selection service.

The helper module 350 is comprised of four main components: a GPS interface 360; a user interface 370; a network interface 380; and a surrogate (or surrogate) session manager 390. The surrogate session manager 390 contains any the algorithm required to manage and internally process the user's request for help/surrogate services. In addition, the surrogate session manager 390 processes incoming information from the server 15 and the GPS system 450. The GPS 450, through a transceiver 400, relays current location information to the surrogate session manager 390, providing necessary user location information for proper help/surrogate selection.

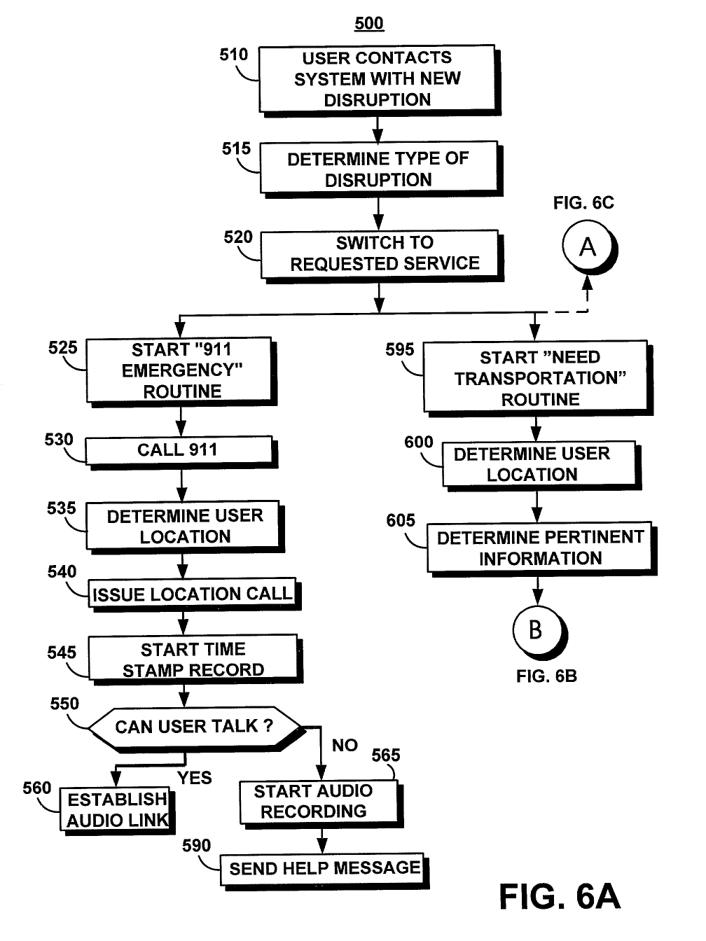

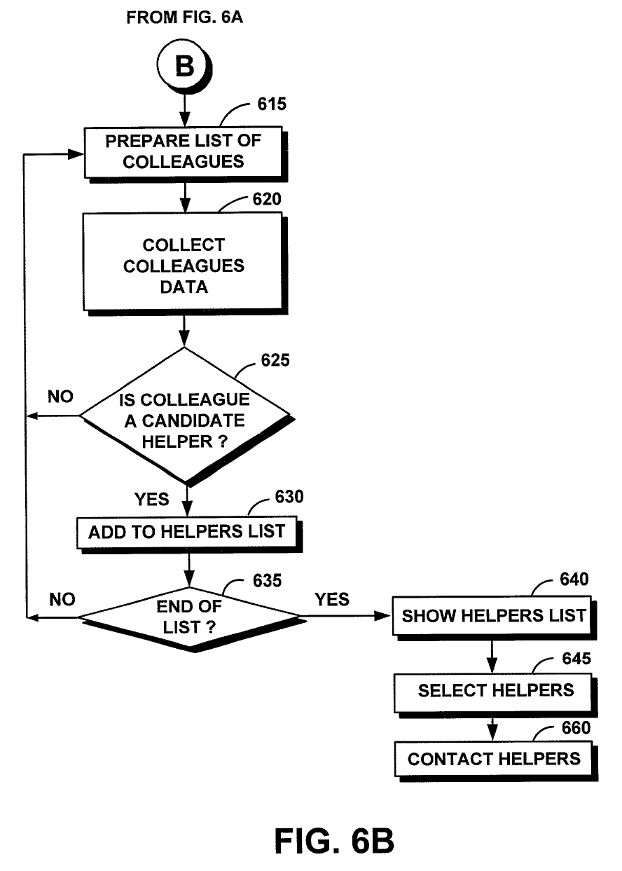

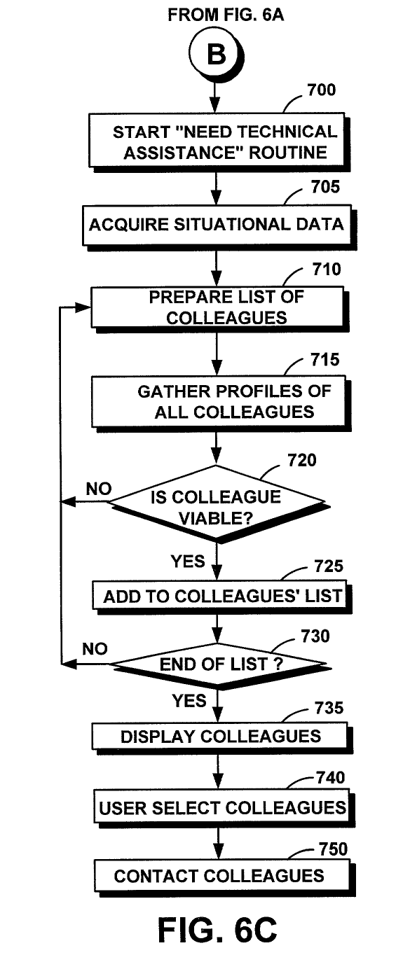

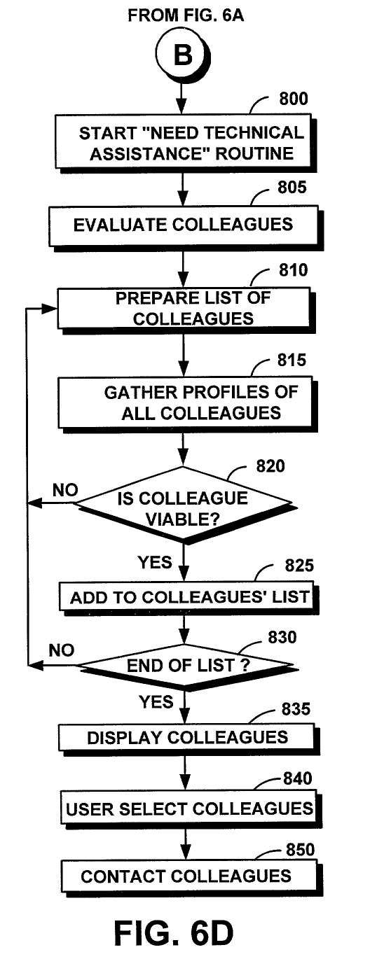

FIG. 6, which is comprised of FIGS. 6A, 6B, 6C, and 6D, depicts a process flowchart of a method or algorithm 500 that drives the disruption recovery aspect of the system 10, as applied to a disruption recovery situation, for allowing a client to request assistance based on a current need, a current (or future) location, and personal preferences. It should be clear that this method is similarly applicable to the implementation of a surrogate selection feature.

In the initial step of method 500, a client perceives the need for disruption recovery and contacts the notification system 10. The service receives the disruption call 510 from the user. The server 15 determines, at step 515, the category of the disruption, based on its pre-defined categories. At this step an internal disruption variable dT is set.

Based on the value of the disruption variable dT, that is based on the disruption type, method 500 switches or branches to one of a plurality of alternative service recovery routines at step 520. In the present example, method 500 will be described in relation to four such recovery routines: “911 Emergency” routine which is initiated at step 525; “Need Transportation” routine which is initiated at step 595; “Need Technical Assistance” routine which is initiated at step 700; or “Need Information Resource” routine which is initiated at step 800.

In the event of a 911 emergency call at step 525, the system issues a 911 call at step 530, and determines the user's location at step 535. Method 500 then issues a location call to an emergency response system (such as 911) at step 540, and then begins a time-stamped record of the subsequent interchange with the user.

At step 550 the server module 150 determines if the user is able to communication verbally, i.e., if the user is able to talk. If the answer is affirmative, method 500 proceeds to step 555, and establishes an audio link with the user at step 560. However, if method 500 determines at decision step 550 that the user is unable to communication verbally, it starts an audio recording 565, and transmits this information along with an annotated help message to an emergency crew at step 590.

In the event that the disruption is a requirement for transportation, the variable dT is set to the “Need Transportation” routine at step 595. Method 500 then determines the user's location based on GPS input, at step 600.

At step 605, the system determines information that is pertinent to the situation at hand. In particular, it determines the current time, the time for the client's next required activity, the location of the new activity and the distance to the next required event. This information is acquired from the GPS system 450, the client database 80, the calendar database 90, and the Locations database 100.

Based on this information, the system 10 generates a list of potential helpers at step 615 of FIG. 6B. In this flowchart, the potential helpers are referred to as “colleagues”. At step 620, the system 10 begins to acquire the necessary colleague information. In particular, based on information in the databases 80, 90, 95, 100, and 105 of FIG. 5, along with information provided by the GPS system 450, the server constructs a colleague profile including: location, distance to client location, time to the colleague's next required event, the profile of the colleague (including resources such as access to a car, etc.), distance and estimated time of arrival to the user's current location.

At step 625, the data is analyzed to determine if the identified colleague is a viable source of help, i.e., whether the colleague a candidate or potential helper. Specifically, method 500 determines if the colleague could reach the user and provide a timely service. If the answer is in the affirmative, the server 15 adds this colleague to a generated helpers list at step 630. Otherwise, method 500 returns to step 615 and repeats step 620 as described earlier.

At step 635 method 500 determines if method 500 has considered all the colleagues, i.e., if it has reached the end of the helpers' list. If it has not, it returns to step 615 and repeats steps 620, 625, 630, and 635 as described earlier, to reconstruct yet another colleague profile.

However, if the helpers' end of list has been reached, method 500 proceeds to step 640 where the list of colleagues is displayed or otherwise relayed to the user. The user has the option of selecting one or more helpers from the list of helpers made available to him or her, and the system 10 contacts the viable helper or helpers at step 660 to confirm their availability. If no helper is available to assist the user, a message, such as “Sorry, no help found” is displayed to the user.

Turning now to FIG. 6C, in the event that the disruption is a requirement for technical assistance, method 500 starts the “Need Technical Assistance” routine at step 700. At step 705, situational information is gathered. Specifically, the system 10 determines the current time, the time until the client's next required activity; and the difference between these two times. This information is acquired from the client database 80 and the calendar database 90 (FIG. 5).

Based on this information, the system 10 prepares a list of potential helpers at step 710, referred to as “colleagues” in the flowchart. At step 715 the system 10 begins to acquire the necessary colleagues profiles. In particular, based on the information in the databases 80, 90, 95, 100, and 105 of FIG. 5, along with information provided by the GPS system 450, the server 15 constructs a profile for each colleague, that includes, for example, the following information:

colleague location;

distance from the colleague to client location;

time of the colleague's next required event;

the time remaining before the colleague's next required event;

the colleague's next required location;

the profile of the colleague, including the colleague's field of expertise and resources that can be brought to bear on the problem at hand;

time to reach the user's current location;

time to get from the user's location to the colleague's next required event; and

estimated time to help the user.

With this information now collected, the system 10 can determine whether the colleague is able to help the user at decision step 720. Specifically, the system 10 determines if there is a skills and/or resource match and then it calculates if the sum of times it would take to reach the user, provide the necessary help, and then travel to the colleague's next location is less than or equal to the time till the colleague's next required event.

The system 10 further determines if the time for the colleague to travel to the user and then help the user is less than the time till the user's next event. If the answers to these inquiries are in the affirmative, the colleague is added to the colleagues' list at step 725. Otherwise, method 500 eliminates the colleague and returns to step 710 to consider another potential colleague. This loop is completed when the end of the colleagues' list is reached, at which point, a colleagues' list is displayed to the user at step 735.

The user selects one or more colleagues from the colleagues' list at step 740. In the event that no colleague is available, a message, such as “Sorry no help found” is displayed to the user. Presuming that the colleague's list contains at least one viable colleague, the system 10 contacts the selected colleague or colleagues, at step 750, who would then provide the necessary technical assistance to the user.

Turning now to FIG. 6D, in the event that the disruption is a requirement for additional information or resources, method 500 starts the “Need Information Resource” routine at step 800. Method 500 begins to sequentially evaluate each colleague in the database for a potential service and time match, at step 805, specifically gathering information about the colleague profile and an evaluation of the colleague's present activity. Method 500 then prepares a list of potential colleagues at step 810.

If method 500 determines at decision step 830 that the colleague is viable, that is available and has the correct profile, that colleague is added to a colleagues' list at step 825. Otherwise, method 500 loops back to step 805 to evaluate the next colleague.

The colleagues' list is completed when the colleague data has been fully evaluated at step 830. A list of potential colleagues is then prepared for the user, and is thereafter displayed to the user at step 835. This list is evaluated by the user who then selects one or more potential colleagues that meet the user's expectations, at step 840. The system 10 contacts the selected colleagues requesting that at least one colleague provide the necessary information resources to the user, at step 850.

It is to be understood that the specific embodiments of the present invention that have been described are merely illustrative of certain application of the principle of the present invention. Numerous modifications may be made to the system and associated method described herein without departing from the spirit and scope of the present invention.

What is claimed is:

1. A method to automatically assist a user recover from an unexpected disruption of service, comprising the steps of:
the user sending a notification to a service disruption service requesting assistance;
automatically determining the user's current location;
mapping locations and schedules of candidate helpers who are able to travel to the user's current location to provide assistance;
preparing a list of candidate helpers based on the user's current location and the candidate helpers' locations and schedules; and
automatically dispatching one or more candidate helpers from the list.

2. The method of claim 1, further including the step of sending the list of candidate helpers to the user.

3. The method of claim 2, further including the user selecting the one or more candidate helpers to be automatically dispatched.

4. The method of claim 3, further including the step of determining the user's location for a future task; and
accounting for the user's location for a future task in preparing the list of candidate helpers.

5. The method of claim 4, further including the step of mapping future locations and schedules of the candidate helpers; and
accounting for the candidate helpers' future locations and schedules in preparing the list of candidate helpers.

6. The method of claim 1, wherein the step of sending the notification of the service disruption includes the step of sending an emergency request.

7. The method of claim 6, further including the step of executing an emergency request routine in response to the emergency request.

8. The method of claim 1, wherein the step of sending the notification of the service disruption includes the step of sending a transportation request.

9. The method of claim 8, further including the step of executing a transportation request routine in response to the transportation request.

10. The method of claim 1, wherein the step of sending the notification of the service disruption includes the step of sending a technical assistance request.

11. The method of claim 10, further including the step of executing a technical assistance routine in response to the technical assistance request.

12. The method of claim 1, wherein the step of sending the notification of the service disruption includes the step of sending an information resource request.

13. The method of claim 12, further including the step of executing an information resource routine in response to the information resource request.

14. A method to automatically assist a user locate a surrogate, comprising the steps of:
sending a request for a surrogate to a resource substitution system;
the resource substitution system automatically determining the user's current location;
mapping locations and schedules of candidate surrogates who are able to travel to the user's current location to provide assistance;
preparing a list of candidate surrogates based on the user's current location and the candidate surrogates' locations and schedules; and
automatically dispatching one or more candidate surrogates from the list.

15. The method of claim 14, further including the step of sending the list of candidate surrogates to the user.

16. The method of claim 15, further including the user selecting the one or more candidate surrogates to be automatically dispatched.

17. The method of claim 16, further including the step of determining the user's location for a future task; and
accounting for the user's location for a future task in preparing the list of candidate surrogates.

18. The method of claim 17, further including the step of mapping future locations and schedules of the candidate surrogates; and
accounting for the candidate surrogates' future locations and schedules in preparing the list of candidate surrogates.

19. A service disruption system that automatically assists a user recover from an unexpected disruption of service, comprising:
a client module that transmits a notification to the service disruption requesting assistance;
a server module that automatically determines the user's current location;
the server module mapping locations and schedules of candidate helpers who are able to travel to the user's current location to provide assistance;
the server module further preparing a list of candidate helpers based on the user's current location and the candidate helpers' locations and schedules; and
the server module automatically transmitting a request for assistance to one or more candidate helpers' modules from the list of candidate helpers.

20. The service disruption system of claim 19, wherein the user module includes a client session manager.

21. The service disruption system of claim 20, wherein the user module further includes a GPS interface.

22. The service disruption system of claim 20, wherein at least one of the candidate helpers' modules includes a substitute session manager and a GPS interface.

23. The service disruption system of claim 20, wherein the server module includes a plurality of server information interfaces.

24. The service disruption system of claim 23, wherein the server module further includes a plurality of server information databases.

25. A resource substitution system that automatically assists a user locate a surrogate, comprising:
a user module that sends a request for a surrogate to the resource substitution system;
a server module that automatically determines the user's current location;
the server module maps locations and schedules of candidate surrogates who are able to travel to the user's current location to provide assistance;
the server module prepares a list of candidate surrogates based on the user's current location and the candidate surrogates' locations and schedules; and
the server module automatically transmitting a request for substitution to one or more surrogates' modules from the list of candidate surrogates.

26. A software computer program that automatically assists a user recover from an unexpected disruption of service, comprising:
means for transmitting a request for assistance;
means for automatically determining the user's current location;
means for mapping locations and schedules of candidate helpers who are able to travel to the user's current location to provide assistance;
means for automatically preparing a list of candidate helpers based on the user's current location and the candidate helpers' locations and schedules; and
means for automatically transmitting a request for assistance to one or more candidate helpers from the list of candidate helpers.

27. A software computer program that automatically assists a user locate a surrogate, comprising:
means for sending a request for a surrogate substitution;
means for automatically determining the user's current location;
the means for mapping locations and schedules of candidate surrogates who are able to travel to the user's current location to provide assistance;
means for preparing a list of candidate surrogates based on the user's current location and the candidate surrogates' locations and schedules; and
means for automatically transmitting a request for substitution to one or more surrogates from the list of candidate surrogates.

28. A method to automatically assist a user locate a surrogate, comprising the steps of:
sending a request for a surrogate to a resource substitution system;
mapping locations and schedules of candidate surrogates who are able to travel to a predetermined location to provide a service;
preparing a list of candidate surrogates based on the predetermined location and the candidate surrogates' locations and schedules; and
automatically dispatching one or more candidate surrogates from the list.
